(19) United States
(12) Patent Application Publication
(10) Pub. No.: US 2008/0007812 A1
(43) Pub. Date: Jan. 10, 2008

(54) OPTICAL UNIT FOR USE IN IMAGE FORMING APPARATUS

(75) Inventor: Yasushi Kuribayashi, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Tokyo (JP); Toshiba Tec Kabushiki Kaisha, Tokyo (JP)

(21) Appl. No.: 11/456,341

(22) Filed: Jul. 10, 2006

(51) Int. Cl. G02B 26/08

(52) U.S. Cl. 359/205; 359/207

(57) ABSTRACT

By using an embodiment of the invention, an image forming apparatus capable of controlling an influence on an image due to machining traces that are left, in manufacturing a molding die used for molding lenses, even by cutting and grinding of the molding die.

### BACKGROUND OF THE INVENTION

1. Field of the Invention

The present invention relates to an optical scanning unit built in an image forming apparatus represented by, for example, an electrostatic copying machine or a laser printer, and, more particularly to an optical scanning unit capable of controlling fluctuation in intensity of exposure light for forming an image output on the basis of image data.

2. Description of the Related Art

In an image forming apparatus that transfers a developing agent image onto a transfer medium to obtain an image output, a raster system for providing exposure light for forming an image output on the basis of image data in a direction perpendicular to a direction in which the transfer medium is conveyed and aligning one line of exposure light and a conveyance pitch of the transfer medium to form an image is widely used.

When exposure light is provided by deflection of a laser beam, lenses to which different convergent properties are given depending on an angle of deflection controlled by a distance in a direction perpendicular to a direction in which a transfer medium is conveyed, that is, a width of a transfer medium (in association with an arbitrary position of the width of the transfer medium) are used.

Therefore, a special shape long in the direction perpendicular to the direction in which the transfer medium is conveyed, for example, a shape shown in FIGS. 1A and 1B and items 605a and 605c of FIG. 28 in Japanese Patent Application Publication (KOKAI) No. 2003-71850 is given to the lenses.

In order to create a die (a die for molding) used for molding the lenses of the special shape, as shown in FIG. 6 of the publication, first, a die member is cut by a tool 30 (a die processing machine). In this case, it is known that machining traces along an x direction are formed as shown in FIG. 15B of the publication.

In view of such a background, a method of grinding the die member inclining a grinding tool 40 a predetermined angle with respect to respective directions of an x direction and a y direction is described in the publication (see FIG. 15A of the publication).

However, it is confirmed that, in output of an image output required of resolution equal to or higher than, for example, 1200 dpi (dots per inches), “density unevenness (non-uniformity of image density)” of a developing agent transferred onto the transfer medium is generated because of fluctuation in intensity of exposure light that occurs depending on the machining traces left on the die member.

An influence on an image due to the machining traces (non-uniformity of image density) is at a level visually recognizable by a user even in an exposure system (an optical scanning unit) with which it is easy to grind a die member. For example, in lenses built in an exposure system that uses lenses formed in a rotation-asymmetrical aspherical surface, a degree of machining traces left after the grinding process is importance for determining an image quality of an image output.

### BRIEF SUMMARY OF THE INVENTION

It is an object of the invention to provide an exposing unit and an image forming apparatus including the exposing unit capable of controlling an influence on an image due to machining traces that are left, in manufacturing a molding die used for molding lenses, even by cutting and grinding of the molding die.

The invention provides an optical unit comprising:

a deflecting unit that continuously deflects supplied light in one direction; and

an image forming lens that continuously condenses the light deflected by the deflecting unit on a planned image surface while converging the light into a predetermined sectional beam diameter, wherein

directions in which machining traces of a die member in molding a lens surface of the image forming lens extend are defined to be unparallel and non-perpendicular to both a direction in which the light is deflected and a direction perpendicular to the direction in which the light is deflected.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing an example of an image forming apparatus including an optical scanning unit (an exposing unit) to which an embodiment of the invention is applied;

FIGS. 2 and 3 are schematic diagrams showing an example of an exposing unit (an optical scanning unit) applicable to the image forming apparatus shown in FIG. 1 (FIG. 2 shows a state in which image light deflected by a deflecting unit is cut in a position where an optical path length of the image light is the smallest; and FIG. 3 shows a state in which image light is deflected by the deflecting unit);

FIG. 4 is a schematic diagram showing a characteristic of a shape of lenses of an image forming optical system used in the exposing unit explained with reference to FIGS. 2 and 3;

FIG. 5 is a schematic diagram for explaining an example of a machining method for a die member used in molding the lenses shown in FIG. 4;

FIG. 6 is a schematic diagram schematically showing machining traces left on the die member by the machining method shown in FIG. 5;

FIG. 7 is a schematic diagram showing an example of another embodiment of a combination of directions of the machining traces left on the die member by the machining method shown in FIG. 5, that is, directions of the machining traces transferred onto lens surfaces of the lens shown in FIG. 4;

FIG. 8 is a schematic diagram showing an example of still another embodiment of the combination of directions of the machining traces left on the die member by the machining method shown in FIG. 5, that is, directions of the machining traces transferred onto lens surfaces of the lens shown in FIG. 4;

FIGS. 9A and 9B are photographs showing beam diameters and defocus amounts of image light on an image surface (on a photosensitive drum) in the case in which angles formed by directions in which the machining traces on the lens surface shown in FIG. 4 (FIG. 5) (machining traces of a portion corresponding to the lens surfaces of the die member) extend and an arbitrary axis are in a relation of θ1≠θ2≠θ3≠θ4;

FIG. 10 is a schematic diagram for explaining the defocus amounts (distances from the image surface) in FIGS. 9A and 9B;

FIGS. 11A and 11B are photographs showing beam diameters and defocus amounts of image light on an image surface in the case in which directions in which the machining traces on the lens surfaces shown in FIG. 7 (machining traces of a portion corresponding to the lens surfaces of the die member) extend are unparallel and non-perpendicular to both a main scanning direction and a sub-scanning direction on at least one of the lens surfaces; and

FIGS. 12A and 12B are photographs showing beam diameters and defocus amounts of image light on an image surface (on a photosensitive drum) in the case in which directions of machining traces on lens surfaces of two lenses of an image forming optical system (an exposing unit) are parallel to a sub-scanning direction for all the lens surfaces (a comparative example).

### DETAILED DESCRIPTION OF THE INVENTION

An embodiment of the invention will be hereinafter explained with reference to the drawings.

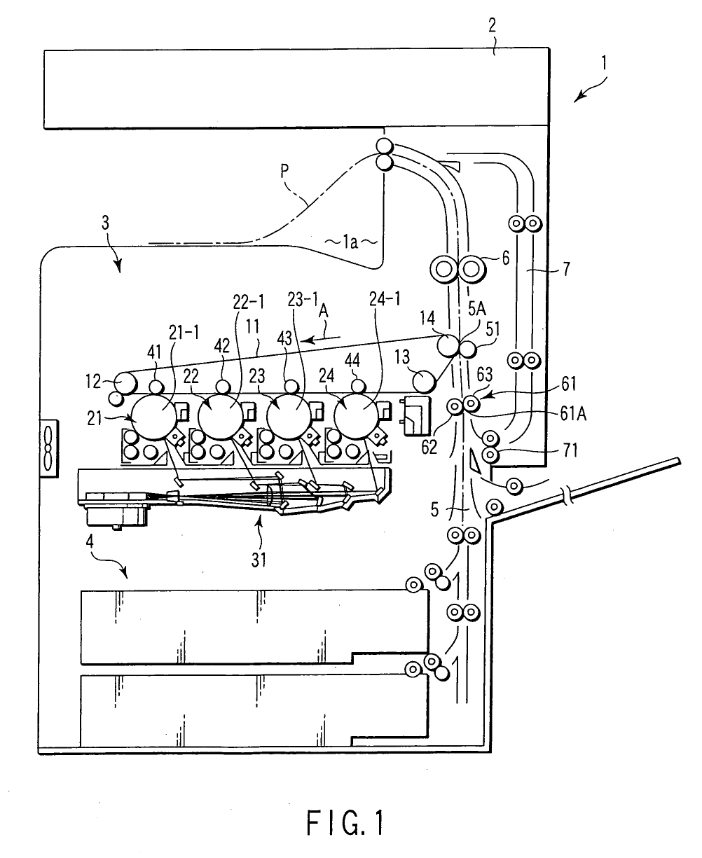

FIG. 1 shows an example of an image forming apparatus including an optical scanning unit (an exposing unit) to which the embodiment of the invention is applied. In the explanation of the embodiment, an example of the invention will be explained with a copying apparatus as an example. However, it goes without saying that the invention is applicable to an arbitrary apparatus such as a printer apparatus, a facsimile apparatus, or a workstation apparatus.

The image forming apparatus, that is, a color copying apparatus 1 includes a scanner unit 2 that grasps image information held by a copy object as light and shade of light and generates an image signal and an image forming unit 3 that transfers a toner image visualized by a developing agent, that is, a toner onto a transfer medium, that is, sheet-like paper P used for an output (output paper) called hard copy or print out and outputs the output on the basis of the image signal generated by the scanner unit 2.

Paper is provided to the image forming unit 3, every time a toner image is formed, from a paper holding unit 4 that holds an arbitrary number of pieces of the sheet-like paper P having a predetermined size and is capable of providing the paper P one by one according to timing when the toner image is formed in the image forming unit 3.

A conveyance path 5 that guides the paper P from the paper holding unit 4 toward the image forming unit 3 is provided between the paper holding unit 4 and the image forming unit 3. The conveyance path 5 guides the paper P to a fixing unit 6, which fixes a toner image transferred onto the paper P on the paper-P as explained later, through a transfer position 5A where a toner image formed in the image forming unit 3 is transferred as explained later. The conveyance path 5 also functions as a paper passage that guides the paper P having the toner image fixed thereon by the fixing unit 6 to an image output holding unit la that also serves as a part of a cover over the image forming unit 3 and is defined in a space between the image forming unit 3 and the scanner unit 2.

The image forming unit 3 has an intermediate transfer belt 11 obtained by forming, for example, an insulative film of predetermined thickness in an endless belt shape. A belt obtained by forming metal in a thin sheet shape and protecting the surface of the metal with resin or the like can also be used as the intermediate transfer belt 11.

Predetermined tension is given to the intermediate transfer belt 11 by a driving roller 12, a first tension roller 13, and a second tension roller 14. When the driving roller 12 is rotated, an arbitrary position parallel to an axis of the driving roller 12 is moved in a direction of an arrow A. In other words, a belt surface of the intermediate transfer belt 11 is turned in one direction at speed at which the outer peripheral surface of the driving roller 12 is moved.

First, second, third, and fourth image forming units 21, 22, 23, and 24 are arranged at predetermined intervals in a section where the belt surface of the intermediate transfer belt 11 is moved substantially flatly in a state in which the predetermined tension is given to the intermediate transfer belt 11 by arbitrary rollers. In the example shown in FIG. 1, the first image forming unit 21 is located on the side of the driving roller 12 and the fourth image forming unit 24 is located on the side of the first tension roller 13 in a section where the belt surface of the intermediate transfer belt 11 is moved substantially flatly between the driving roller 12 and the first tension roller 12.

Each of the first to the fourth image forming units 21 to 24 includes at least developing units in which toners of arbitrary colors of C (cyan), M (magenta), Y (yellow), and BK (black) are stored and photosensitive drums 21-1, 22-1, 23-1, and 24-1 that hold electrostatic images that the respective developing units should develop. Electrostatic images (latent images) corresponding to images of colors that the developing units set in the image forming units should develop are formed on the surfaces (the outer peripheral surfaces) of the photosensitive drums of the respective image forming units by image light from an exposing unit 31. The toners are selectively supplied by the developing units corresponding thereto. As a result, developed image, that is, toner image of colors defined in advance are formed on the respective photosensitive drums.

Transfer rollers 41 to 44 for transferring toner images held by the respective photosensitive drums to the intermediate transfer belt 11 are provided in positions opposed to the respective photosensitive drums on the rear surface side of the intermediate transfer belt 11 in a state in which the intermediate transfer belt 11 is interposed between the respective photosensitive drums and the respective first to fourth image forming units 21 to 24.

In the respective image forming units 21 to 24, electrostatic images are formed at predetermined timing on the intermediate transfer belt 11 and developed by the developing units such that toner images that are (should be) sequentially transferred are superimposed one on top of another on the intermediate transfer belt 11.

A (full-color) toner image obtained by superimposing the toner images one on top of another on the intermediate transfer belt 11 is transferred onto the paper P, which is guided to the transfer position 5A, by a transfer roller 51 brought into contact with the intermediate transfer belt 11 at a predetermined pressure in the transfer position 5A of the conveyance path 5.

A registration roller 61 that temporarily stops the paper P guided from the paper holding unit 4 toward the transfer position 5A is provided in a predetermined position in the conveyance path 5 from the paper holding unit 4 to the transfer position 5A. In the registration roller 61, at least one of rollers rotates in a predetermined direction and the other roller is pressed against one roller with a predetermined pressure via a not-shown press-contact mechanism.

The paper P guided from the paper holding unit 4 toward the transfer position 5A on the conveyance path 5 is temporarily stopped by the registration roller 61. Consequently, inclination (of the paper P itself with respect to a conveyance direction), which may occur while the paper P is conveyed on the conveyance path 5 from the paper holding unit 4, is corrected.

Timing when the toner image carried toward the transfer position 5A following the movement of the belt surface of the intermediate transfer belt 11 comes to the transfer position 5A and timing when the paper P reaches the transfer position 5A are set according to timing when the registration roller 61 is rotated again, whereby a position of the toner image with respect to the paper P is managed (a position of the toner image on the paper P can be set arbitrarily).

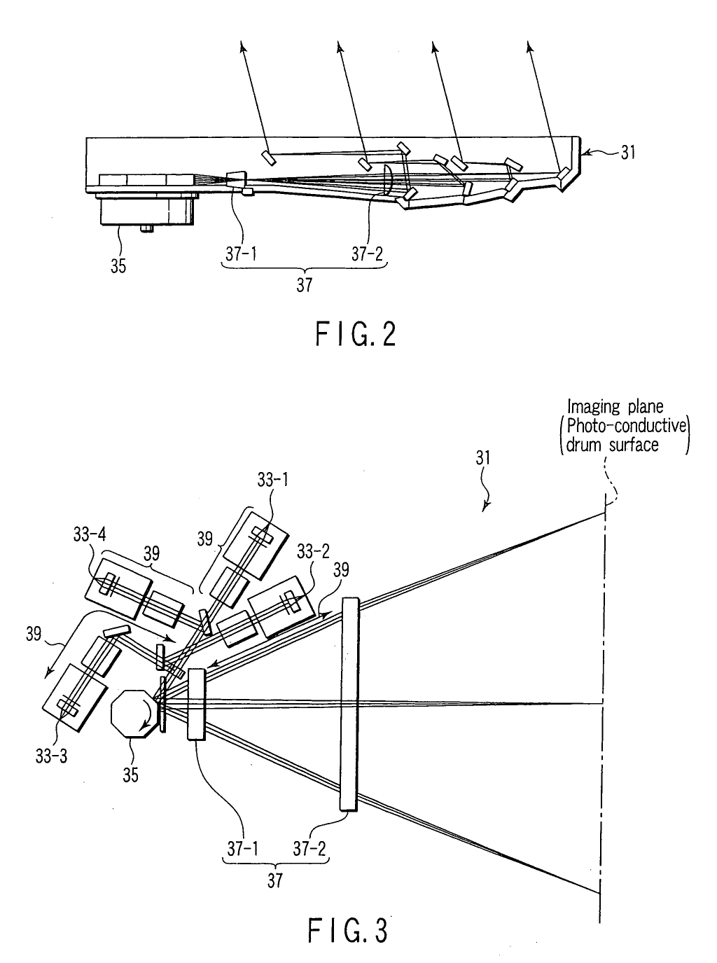

The optical scanning unit (the exposing unit) 31 includes at least, as shown in FIGS. 2 and 3, light sources (semiconductor laser elements) 33-1 to 33-4 that output first to fourth image lights (exposure lights) corresponding to image information subjected to color separation in accordance with a subtractive process used for forming toner images in the respective first to fourth image forming units 21 to 24, a deflecting unit 35 that associates image lights from the respective light sources 33-1 to 33-4 with a raster direction (hereinafter referred to as main scanning direction) in outputting an output (output paper), an image forming optical system 37 that condenses image lights subjected to raster deflection (scanning) by the deflecting unit 35 on the photosensitive drums 21-1, 22-1, 23-1, and 24-1 of the first to the fourth image forming units 21 to 24 under predetermined conditions regardless of an angle of deflection, and an exposure light shaping optical system 39 that guides image lights from the respective light sources 33-1 to 33-4 to the deflecting unit 35 under predetermined conditions.

The deflecting unit 35 has a rotatable reflection element, which is fixed to a shaft of the motor. The deflecting unit 35 is rotated at predetermined speed (number of revolutions) for raster scanning (deflection). The number of reflection surfaces provided in the reflection element and the number of revolutions thereof are defined according to a request for output, that is, resolution, output speed, and the like required of the copying apparatus (the image forming apparatus) 1.

The image forming optical system 37 includes, in positions in longitudinal directions of the respective photosensitive drums 21-1, 22-1, 23-1, and 24-1, that is, in a direction perpendicular to a direction in which paper is conveyed (a direction in which the photosensitive drums are rotated), at least (long slender) lenses 37-1 and 37-2 (extending in the longitudinal directions) to which different convergent properties are given in association with positions (on the photosensitive drums) depending on an angle of deflection, which is a swing angle, of image light subjected to raster scanning by the deflecting unit 35 that is caused when the image light is subjected to raster deflection. The image forming optical system 37 also includes various optical elements (e.g., a mirror(s) and a filter(s)) for guiding the image light subjected to raster scanning by the deflecting unit 35 to the respective photosensitive drums 21-1, 22-1, 23-1, and 24-1 of the first to the fourth image forming units 21 to 24. The lenses 37-1 and/or 37-2 may be replaced with a mirror(s) having a similar curved surface by optimizing types and shapes of the optical elements and using a combination of arrangements.

The exposure light shaping optical system 39 shapes image lights from the respective light sources 33-1 to 33-4 to have a sectional beam shape satisfying predetermined conditions (to be condensed) when the image lights are subjected to raster scanning by the deflecting unit 35 and condensed in predetermined positions in the longitudinal directions of the respective photosensitive drums 21-1, 22-1, 23-1, and 24-1 in the image forming optical system 37. The exposure light shaping optical system 39 includes various optical elements represented by, for example, a condenser(s), a mirror(s),-and an aperture stop(s).

Predetermined intervals corresponding to positions where the respective image forming units 21 to 24 are arranged (substantially equal intervals on the belt surface of the intermediate transfer belt 11) are given to image lights emitted from the optical scanning unit (the exposing unit) 31. Intensity of the image lights themselves are changed by an image signal corresponding to image information, which is subjected to color separation in accordance with a subtractive process, supplied from a not-shown image signal processing system to the light sources 33-1 to 33-4. It goes without saying that a difference of amounts of charges (an amount of residual charges) selectively generated in photosensitive layers of the respective photosensitive drums 21-1, 22-1, 23-1, and 24-1 when the intensity of the image lights is changed becomes the electrostatic image (already explained).

The change in the intensity of the image light is sensitively reflected on the electrostatic image. However, the change in the intensity of the image light does not always correspond to a change in the image signal.

For example, the lens surfaces of the lenses 37-1 and/or 37-2 applied to the image forming optical system 37 involve non-uniformity of shapes obtained by transferring (molding) machining traces remaining on a die member used at the time of molding. It is difficult to substantially eliminate the non-uniformity (an influence of the machining traces) even with the present techniques. When the lens surfaces of the lenses 37-1 and/or 37-2 have a rotation-asymmetrical aspherical shape or a free curved surface shape, grinding for reducing the machining traces (on the die member) is also difficult.

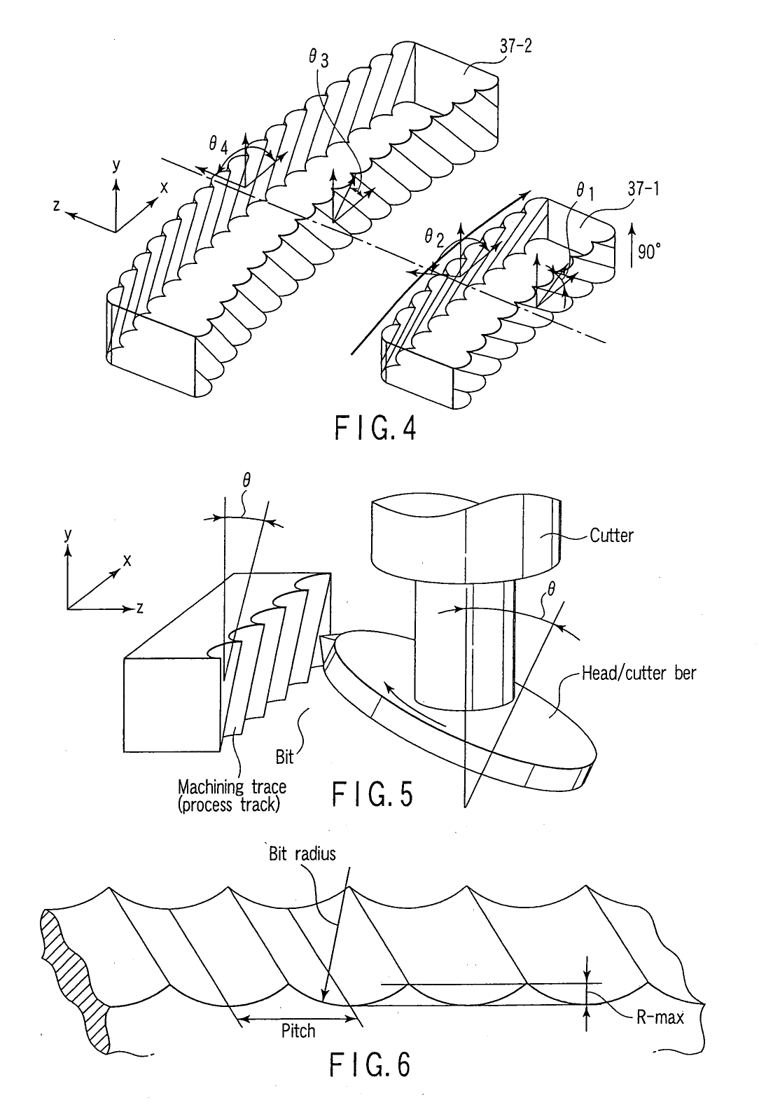

FIG. 4 shows an example of a die machining method capable of controlling a degree of influence of machining traces (a transfer pattern) (of the die member) at the time of molding, which are transferred onto the lens surfaces of the lenses 37-1 and/or 37-2, on an image quality.

The lens surfaces of the lenses 37-1 and/or 37-2 involve (a transfer pattern of) machining traces defined in a direction unparallel and non-perpendicular to both a first direction, that is, a direction in which image light is continuously deflected in image formation by the raster system (hereinafter referred to as “main scanning direction”) and a second direction perpendicular to the first direction, that is, a direction in which the photosensitive drums are rotated, which is a direction in which the paper P used for image output is conveyed (hereinafter referred to as “sub-scanning direction”).

In a die member 111 (schematically shown in FIG. 5) used in molding the lenses 37-1 and/or 37-2 (see FIG. 4), portions 111-α and/or 111-β corresponding to the lens surfaces are machined by a machining tool (a die cutter) that rotates with a direction (indicated by an arrow affixed with s) unparallel to and non-perpendicular to both the main scanning direction (indicated by an arrow affixed with x) and the sub-scanning direction (indicated by an arrow affixed with y) as a rotation center. A general-purpose cutter can be used as the machining tool (although not described in detail). The machining tool can easily realize cutting in a direction (indicated by an arrow affixed with m) unparallel and non-perpendicular to both the main scanning direction and the sub-scanning direction and parallel to the rotation center according to setting of an angle of a cutter head or a cutter bar. It is preferable that machining directions of die members used for molding the respective lens surfaces (i.e., a transfer pattern of machining traces left on the lens surfaces) are defined as different directions on all the lens surfaces.

By moving the machining tool in the arrow m direction in accordance with the principle (the machining method) shown in FIG. 5, directions of the machining traces left on the lens surfaces of the lenses 37-1 and/or 37-2 (see FIG. 4) become substantially parallel to the arrow s direction shown in FIG. 5. It is preferable that an angle formed by the arrow s direction and the main scanning direction x or the sub-scanning direction y is unparallel and non-perpendicular to all angles obtained by a division with the number of all the lens surfaces (a total of the lens surfaces) of the (long slender) lenses (extending in the longitudinal direction) of the image forming optical system 37 set as a denominator. Since the number of the lens surfaces is usually an even number, it is preferable that the directions of the machining traces left on the respective lens surfaces are unparallel and non-perpendicular to one another. It is also useful to incline a rotating direction of the cutter head/the cutter bar with respect to the main scanning direction and the sub-scanning direction, respectively (giving a deflection angle to the cutter head/the cutter bar) in that a machining radius larger than an original rotation radius of the cutter head/the cutter bar is obtained in a section in a certain direction. This machining method (of inclining a rotating direction of the cutter head/the cutter bar with respect to the main scanning direction and the sub-scanning direction, respectively) is particularly useful when a curvature of a machining object is close to “0 (plane)” or when a sign of a curvature of a machining object is opposite to a curvature of a rotation radius of the cutter head/the cutter bar.

As explained above, on the lens surfaces of the respective lenses, when the directions in which the machining traces of the portion corresponding to the lens surfaces of the die member are represented as angles from an arbitrary axis, for example, the main scanning direction (the x axis), it is preferable that the angles are in a relation of θ1 (the first lens surface) ≠θ2 (the second lens surface) ≠θ3 (the third lens surface) ≠θ4 (the fourth lens surface). In this case, when easiness of machining of the die member, equalization of a balance (a degree of influence) of the main scanning direction and the sub-scanning direction, or interference among the machining traces on the lens surfaces (the mold member) is taken into account, for example, when there are four lens surfaces (the number of lenses is two), the angles θ1 to θ4 may be set at intervals of 45°, respectively. When the rotating direction of the cutter head/the cutter bar is set to 45° with respect to the main scanning direction and the sub-scanning direction, respectively, this means that the balance (the degree of influence) of the main scanning direction and the sub-scanning direction is equalized most for lens surfaces (two surfaces) when a single lens is considered.

When a mirror(s) having the similar curvature is used, a total number of lens surfaces and/or mirror surfaces may be an odd number but is principally identical.

FIG. 6 schematically shows the machining traces left on the die member by the machining method shown in FIG. 5. The machining traces include plural (i.e., the number of pitches) projected portions with different sizes related to pitches of movement of the cutter head or the cutter bar when the cutter head or the cutter bar of the cutter is repeatedly moved. A size of the projected portion is, when represented in Rmax, Rmax≦0.02 μm in accordance with, for example, a method of displaying surface roughness. By setting a size of the projected portion of the portion corresponding to the lens surfaces of the die member to the numerical value described above, even in a state in which image light to which predetermined convergent properties are given by the lenses 37-1 and/or 37-2 is condensed on the photosensitive layers of the photosensitive drums, it is possible to control undesired deformation of a sectional beam shape of the image light or an undesired increase in intensity of a side lobe affecting an image quality.

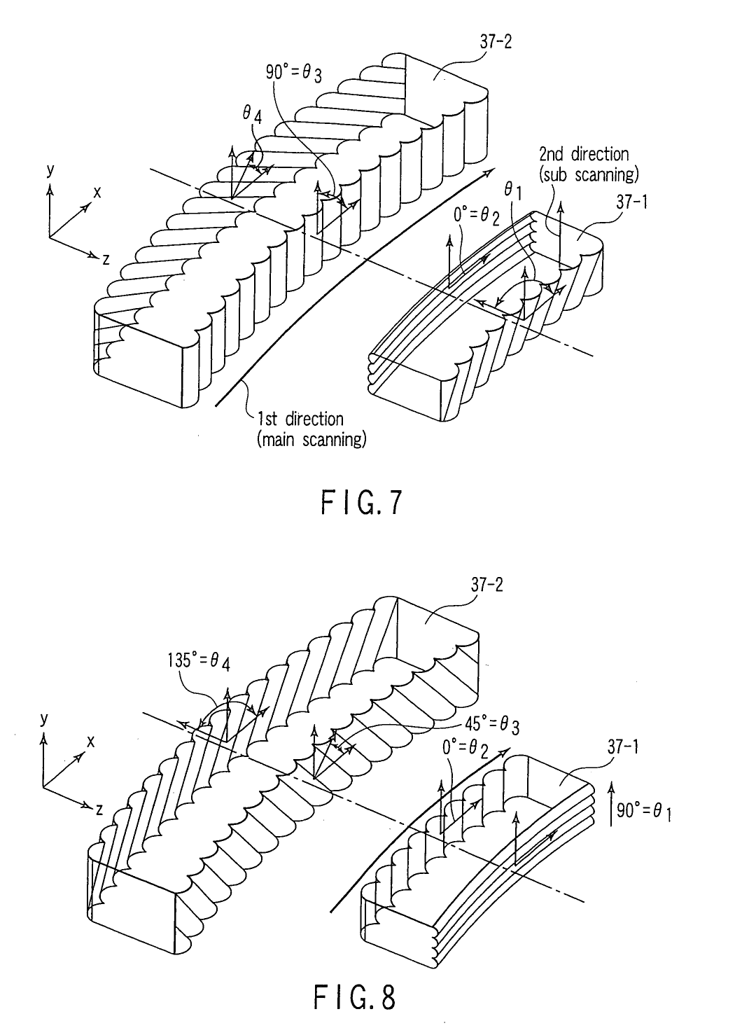

FIG. 7 shows an example of another embodiment of a combination of directions of the machining traces left on the die member by the machining method shown in FIG. 5, that is, directions of the machining traces transferred onto the lens surfaces of the lens shown in FIG. 4.

Ideally, it is preferable to set directions of the machining traces left on all the lens surfaces at random as shown in FIG. 4. However, naturally, cost increases. Thus, for example, in the optical scanning unit (the exposing unit) 31 shown in FIGS. 2 and 3, it is preferable to set directions of the machining traces on at least one lens surface of the two lenses 37-1 and 37-2 to be unparallel and non-perpendicular to both the main scanning direction and the sub-scanning direction. Since there are two lenses, it is preferable to set, for each of the lenses, directions of machining traces on at least one lens surface to be unparallel and non-perpendicular to both the main scanning direction and the sub-scanning direction.

FIG. 8 shows an example of still another embodiment of the combination of directions of the machining traces left on the die member by the machining method shown in FIG. 5, that is, directions of the machining traces transferred onto the lens surfaces of the lens shown in FIG. 4.

For example, assuming application of the optical scanning unit (the exposing unit) 31 shown in FIGS. 2 and 3 to two lenses, for two lens surfaces of one of the lenses, a combination of directions in which machining traces are defined in directions of 45° with respect to the main scanning direction and the sub-scanning direction, respectively, and extend in directions perpendicular to each other is preferable. For two lens surfaces of the remaining lens, a combination of directions in which extending directions of machining traces of the respective lens surfaces are parallel to one of the main scanning direction and the sub-scanning direction and the respective extending directions are perpendicular to each other.

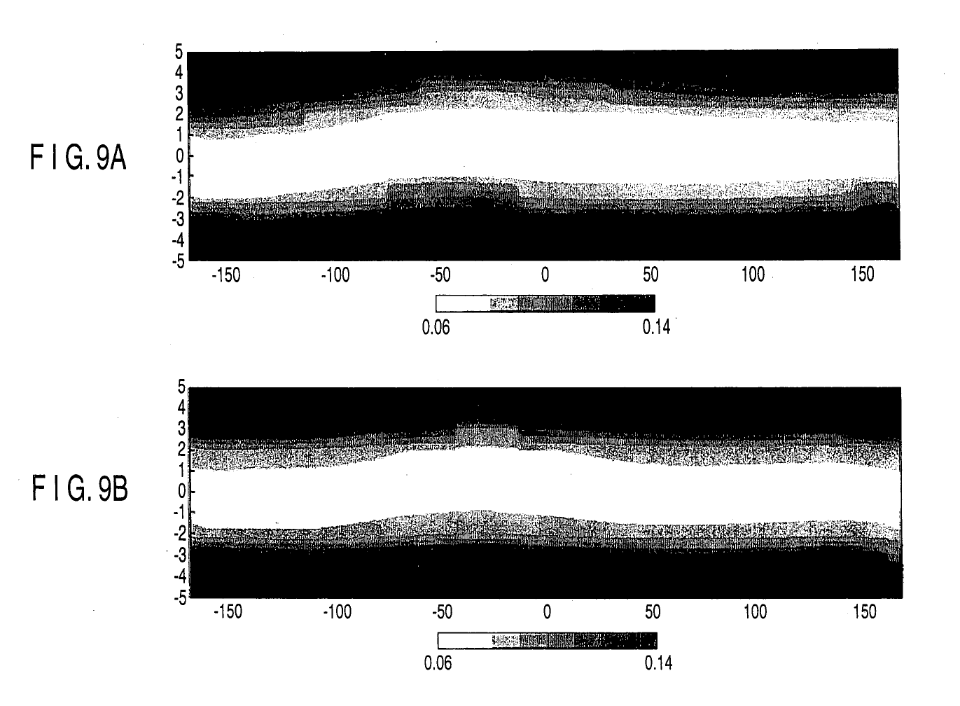

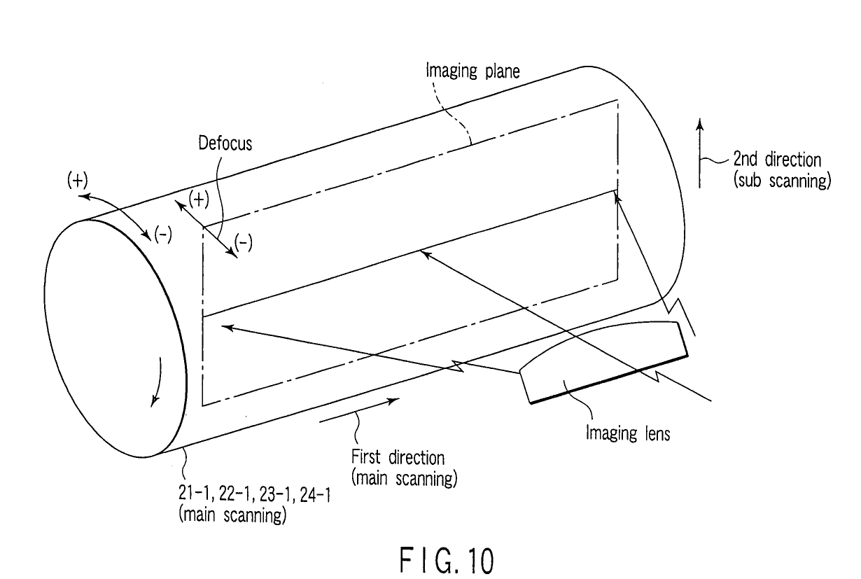

FIGS. 9A and 9B show beam diameters-and defocus amounts of image light on an image surface (on a photosensitive drum) in the case in which angles formed by directions in which the machining traces on the lens surface shown in FIG. 4 (FIG. 5) (machining traces of a portion corresponding to the lens surfaces of the die member) extend and an arbitrary axis are in a relation of θ16 θ2≠θ3≠θ4. FIG. 9A shows an amount of fluctuation in a sectional beam diameter due to defocus in the main scanning direction and FIG. 9B shows an amount of fluctuation in sectional beam diameter due to defocus in the sub-scanning direction. In FIGS. 9A and 9B, an image surface scanning position is substantially equivalent to a width of the paper P used for image output (length in a direction perpendicular to the direction in which the paper P is conveyed). Concerning the defocus amounts (distances from the image surface), the front side of the image surface (on the photosensitive drum) is indicated as [−] and the inner side of the image surface is indicated as [+] (see FIG. 10).

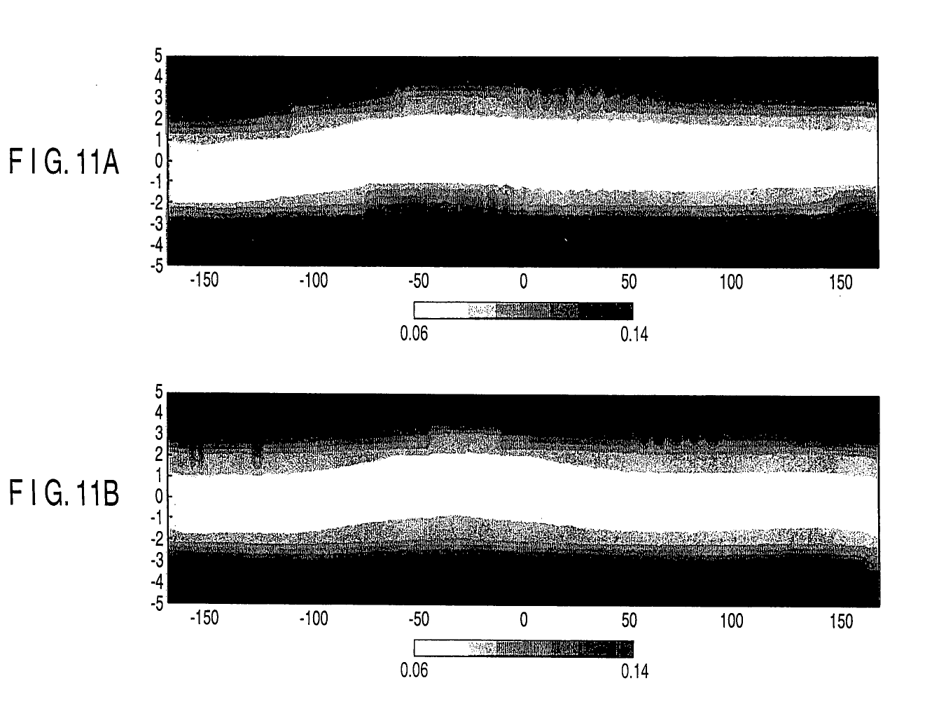

FIGS. 11A and 11B shows beam diameters and defocus amounts of image light on an image surface in the case in which directions in which the machining traces on the lens surfaces shown in FIG. 7 (machining traces of a portion corresponding to the lens surfaces of the die member) extend is unparallel and non-perpendicular to both a main scanning direction and a sub-scanning direction on at least one of the lens surfaces. FIG. 11A shows an amount of fluctuation in a sectional beam diameter due to defocus in the main scanning direction and FIG. 11B shows an amount of fluctuation in a sectional beam diameter due to defocus in the sub-scanning direction. A definition of the defocus amounts (distances from the image surface) is identical with the example defined in FIG. 10.

Superiority of characterization of machining traces of the invention as claimed in this application is unclear from FIGS. 9A, 9B, 11A, and 11B. However, the superiority is clarified by comparing the characterization with a result of evaluation concerning a typical exposing unit in which directions in which machining traces extend are parallel to the sub-scanning direction for all the lens surfaces.

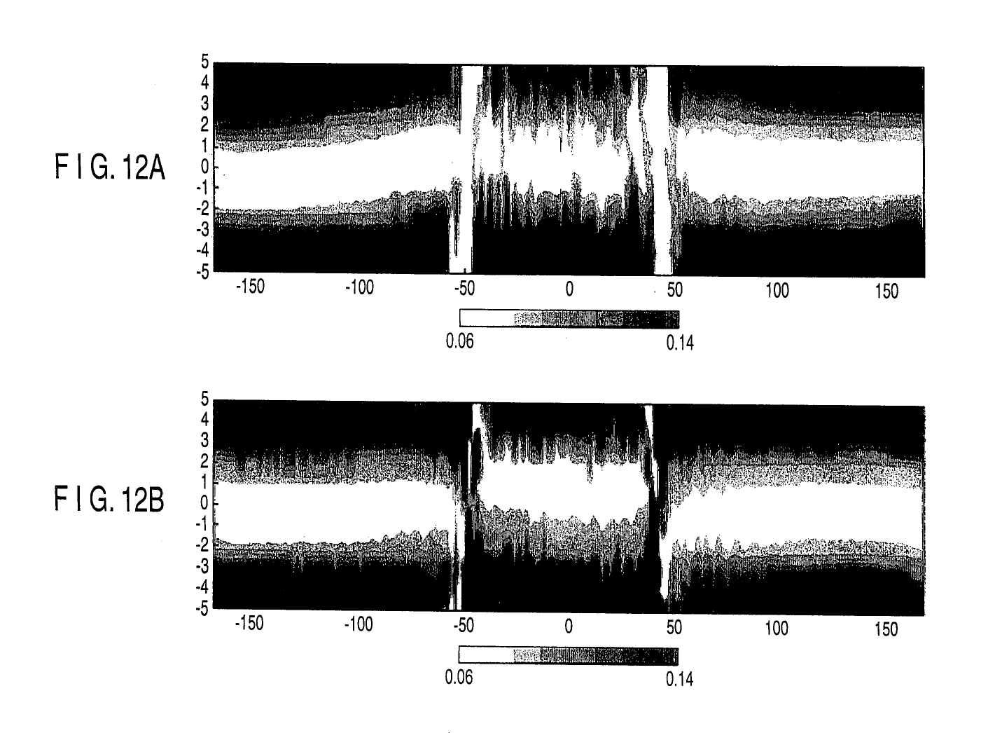

In FIGS. 12A and 12B, in the case in which directions of the machining traces on the lens surfaces of the two lenses 37-1 and 37-2 of the image forming optical system 37 (the exposing unit 31) are set to be parallel to the sub-scanning direction for all the lens surfaces, it is recognized that, when an angle of deflection of image light deflected by the deflecting unit 35 takes a specific angle, a position (a scanning position) where beam diameters of image lights are non-uniform (an interference component is generated) is present on an image surface because of interference of image light that has passed a projected area (or an area in which a projection amount is relatively smallest) of the machining traces.

As explained above, occurrence of an undesired density difference in image output is reduced by using the exposing unit (the optical scanning unit) of the invention. In other words, there is provided an exposing unit and an image forming apparatus including the exposing unit capable of controlling an influence on an image due to machining traces that are left, in manufacturing a molding die used for molding lenses, even by cutting and grinding of the molding die. Therefore, in an image forming apparatus required of particularly high output resolution, reproducibility of an image with a slight density difference (a halftone) is improved.

Advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical unit comprising:
a deflecting unit configured to continuously deflect supplied light in one direction; and
an image forming lens configured to continuously condense the light deflected by the deflecting unit on a planned image surface while converging the light into a predetermined sectional beam diameter, wherein
directions in which machining traces of a die member in molding a lens surface of the image forming lens extend are defined to be unparallel and non-perpendicular to both a direction in which the light is deflected and a direction perpendicular to the direction in which the light is deflected.

2. An optical unit according to claim 1, wherein directions in which the machining traces on the lens surfaces of the image forming lens extend are defined to be unparallel and non-perpendicular to one another.

3. An optical unit according to claim 2, wherein directions in which the machining traces on the lens surfaces of the image forming lens are defined in directions perpendicular to one another.

4. An optical unit according to claim 3, wherein
directions in which the machining traces on one of the lens surfaces of the image forming lens extend are defined to be parallel to the direction in which the light is deflected, and
directions in which the machining traces on the remaining surfaces of the lens surfaces extend is defined in a direction parallel to the direction perpendicular to the direction in which the light is deflected.

5. An optical unit according to claim 1, wherein directions in which the machining traces on at least one of the lens surfaces of the image forming lens extend is defined in a direction parallel to the direction in which the light is deflected or the direction perpendicular to the direction in which the light is deflected.

6. An optical unit according to claim 5, wherein
directions in which the machining traces on one of the lens surfaces of the image forming lens extend are defined in a direction parallel to the direction in which the light is deflected, and
directions in which the machining traces on the remaining surfaces of the lens surfaces extend are defined in a direction parallel to the direction perpendicular to the direction in which the light is deflected.

7. An optical output unit comprising:
a deflecting unit configured to deflect light emitted from a light source in a first direction;
a first imaging lens configured to include a first surface extending in the first direction and facing the deflecting unit side and a second surface opposed to the first surface, the first surface and the second surface including projection patterns obtained as a result of transferring machining traces of a die member at the time of molding onto the first surface and the second surface, and a direction in which the projection pattern extends of the first surface and a direction in which the projection pattern extends of the second surface being defined to be unparallel and non-perpendicular to both the first direction and a second direction perpendicular to the first direction; and
a second imaging lens configured to include a first surface extending in the first direction and facing the first imaging lens side and a second surface opposed to the first surface, the first surface and the second surface including projection patterns obtained as a result of transferring machining traces of a die member at the time of molding onto the first surface and the second surface, and a direction in which the projection pattern extends of the first surface and a direction in which the projection pattern extends of the second surface being defined to be unparallel and non-perpendicular to both the first direction and a second direction perpendicular to the first direction.

8. An optical output unit according to claim 7, wherein the direction in which the projection pattern extends of the first surface and the direction in which the projection pattern extends of the second surface of each of the first imaging lens and the second imaging lens are defined to be unparallel and non-perpendicular to each other.

9. An optical output unit according to claim 7, wherein at least one of the direction in which the projection pattern extends of the first surface and the direction in which the projection pattern extends of the second surface of each of the first imaging lens and the second imaging lens is defined in a direction parallel to the first direction.

10. An optical output unit according to claim 9, wherein at least one of the direction in which the projection pattern extends of the first surface and the direction in which the projection pattern extends of the second surface of each of the first imaging lens and the second imaging lens is defined in a direction perpendicular to the first direction.

11. An optical output unit according to claim 10, wherein a lens surface in the direction in which the direction of extension of the projection pattern is perpendicular to the first direction and a lens surface in the direction in which the direction of extension of the projection pattern is parallel to the first direction are integrated in one of the first imaging lens and the second imaging lens.

12. An optical output unit according to claim 8, wherein angles of θ1, θ2, θ3, and θ4 with respect to the first direction are given to the direction in which the projection pattern extends of the first surface and the direction in which the projection pattern extends of the second surface of each of the first imaging lens and the second imaging lens, respectively, and are preferably in a relation of θ1≠θ2≠θ3≠θ4.

13. An optical output unit according to claim 7, wherein
the direction in which the projection pattern extends of the first surface and the direction in which the projection pattern extends of the second surface of each of the first imaging lens are defined in directions perpendicular to each other, and
the direction in which the projection pattern extends of the first surface and the direction in which the projection pattern extends of the second surface of the second imaging lens are defined in directions perpendicular to each other.

14. An optical output unit according to claim 12, wherein
the direction in which the projection pattern extends of the first surface and the direction in which the projection pattern extends of the second surface of each of the first imaging lens are defined in directions perpendicular to each other, and
the direction in which the projection pattern extends of the first surface and the direction in which the projection pattern extends of the second surface of the second imaging lens are defined in directions perpendicular to each other.

15. An image forming apparatus comprising:
an exposing unit including:
a deflecting unit configured to deflect light emitted by a light source in a first direction;
a first imaging lens configured to include a first surface extending in the first direction and directed to the deflecting unit side and a second surface opposed to the first surface, the first surface and the second surface including projection patterns obtained as a result of transferring machining traces of a die member at the time of molding onto the first surface and the second surface, and a direction in which the projection pattern extends of the first surface and a direction in which the projection pattern extends of the second surface being defined to be unparallel and non-perpendicular to both the first direction and a second direction perpendicular to the first direction;
a second imaging lens configured to include a first surface extending in the first direction and directed to the first imaging lens side and a second surface opposed to the first surface, the first surface and the second surface including projection patterns obtained as a result of transferring machining traces of a die member at the time of molding onto the first surface and the second surface, and a direction in which the projection pattern extends of the first surface and a direction in which the projection pattern extends of the second surface being defined to be unparallel and non-perpendicular to both the first direction and a second direction perpendicular to the first direction;
an image holding member configured to hold an electrostatic image corresponding to image light supplied from the exposing unit; and
a developing unit configured to visualize the electrostatic image held by the image holding member.
